(19) United States
(12) Patent Application Publication
(10) Pub. No.: US 2025/0029981 A1
(43) Pub. Date: Jan. 23, 2025

(54) ALKALINE BATTERY

(71) Applicant: Panasonic Intellectual Property Management Co., Ltd., Osaka (JP)

(72) Inventors: SATOSHI FUJIYOSHI, Osaka (JP); JUN NUNOME, Kyoto (JP)

(21) Appl. No.: 18/682,629

(22) PCT Filed: Jul. 11, 2022
(86) PCT No.: PCT/JP2022/027254

§ 371 Date: Feb. 9, 2024

(30) Foreign Application Priority Data
Oct. 6, 2021 (JP) 2021-164522

(51) Int. Cl. H01M 4/24; H01M 4/02; H01M 6/08

(52) U.S. Cl. CPC H01M 4/244; H01M 6/08; H01M 2004/028

(57) ABSTRACT

An alkaline dry battery includes a positive electrode, a negative electrode, and a separator disposed between the positive electrode and the negative electrode. The positive electrode contains electrolyte and the negative electrode contains electrolyte. The positive electrode further contains electrolytic manganese dioxide, sodium, and zinc. The electrical potential of the electrolytic manganese dioxide is 300 mV or higher and 340 mV or lower with respect to that of a reference electrode made of mercury oxide. The content of the sodium in the positive electrode is 800 ppm by mass or more and 3000 ppm by mass or less. The content of the zinc in the positive electrode is 2400 ppm by mass or more and 4600 ppm by mass or less.

### TECHNICAL FIELD

The present disclosure relates to alkaline dry batteries.

### BACKGROUND ART

Alkaline dry batteries (alkaline manganese dry batteries) have been widely used because of their larger capacities and larger currents capable of being taken out therefrom than manganese dry batteries.

PTL 1 proposes an alkaline battery that includes a positive electrode containing an electrolytic manganese dioxide, a negative electrode containing zinc or a zinc alloy, a separator disposed between the positive electrode and the negative electrode, and an alkaline electrolyte. The positive electrode contains 0.1 to 0.7 parts by weight of sodium with respect to 100 parts by weight of the electrolytic manganese dioxide, and 0.005 to 0.05 parts by weight of silicon with respect to 100 parts by weight of the electrolytic manganese dioxide.

PTL 2 proposes a battery that contains an electrolytic manganese dioxide, as a positive-electrode active material, in which the average size of mesopores is 6.5 nm or more and 10 nm or less, and the alkali electrical potential is 290 mV or higher and 350 mV or lower.

### CITATION LIST

### Patent Literature

PTL 1: Japanese Patent Laid-Open Publication No. 2007-287672

PTL 2: International Publication WO 2020/110951

### SUMMARY OF INVENTION

An electrolytic manganese dioxide providing a high electrical potential used as a positive-electrode active material improves high-rate discharge performance, but may deposit needle crystals of zinc oxide on the positive electrode during medium-rate discharge. Growth of the needle crystals damages a separator, which may result in an internal short circuit.

An alkaline dry battery according to an aspect of the present disclosure includes a positive electrode, a negative electrode, and a separator disposed between the positive electrode and the negative electrode. The positive electrode contains an electrolyte, and the negative electrode contains an electrolyte. The positive electrode further contains electrolytic manganese dioxide, sodium, and zinc. An electrical potential of the electrolytic manganese dioxide is 300 mV or higher and 340 mV or lower with respect to the electrical potential of a reference electrode made of mercury oxide. The content of the sodium in the positive electrode is 800 ppm by mass or more and 3000 ppm by mass or less. The content of the zinc in the positive electrode is 2400 ppm by mass or more and 4600 ppm by mass or less.

The alkaline dry battery according to the present disclosure reduces the occurrence of an internal short circuit therein during medium-rate discharge while enhancing its high-rate discharge performance.

### BRIEF DESCRIPTION OF DRAWINGS

FIG. 1 is a schematic diagram of an apparatus for measuring an electrical potential of an electrolytic manganese dioxide of a positive electrode of an alkaline dry battery according to an exemplary embodiment of the present disclosure.

FIG. 2 is an elevational view of the alkaline dry battery according to the embodiment in which a lateral half thereof is illustrated as a cross-sectional view.

FIG. 3 is a table showing evaluation results of alkaline dry batteries according to the embodiment of the present disclosure.

FIG. 4 is a table showing evaluation results of alkaline dry batteries according to the embodiment of the present disclosure.

FIG. 5 is a table showing evaluation results of alkaline dry batteries according to the embodiment of the present disclosure.

FIG. 6 is a table showing evaluation results of alkaline dry batteries according to the embodiment of the present disclosure.

### DESCRIPTION OF EMBODIMENTS

An alkaline dry battery according to an exemplary embodiment of the present disclosure includes a positive electrode, a negative electrode, and a separator disposed between the positive electrode and the negative electrode. The positive electrode contains an electrolytic manganese dioxide (hereinafter, referred to as EMD), sodium (Na), and zinc (Zn). The electrical potential of the EMD is 300 mV or higher and 340 mV or lower with respect to a reference electrode made of mercury oxide (Hg/HgO). The Na content in the positive electrode is 800 ppm by mass or more and 3000 ppm by mass or less. The Zn content in the positive electrode is 2400 ppm by mass or more and 4600 ppm by mass or less.

The positive electrode contains an electrolyte and the negative electrode contains an electrolyte. That is, the alkaline dry battery includes the electrolyte in the positive electrode, the electrolyte in the negative electrode, and the other electrolytes (for example, an electrolyte with which a separator is impregnated). The electrolyte in the positive electrode is an electrolyte remaining in the positive electrode after the electrolyte adhering on a surface of the electrode is removed. The electrolyte adhering to the surface is an electrolyte that is to be separated from the positive electrode by allowing the electrolyte to naturally fall by the method to be described later.

The electrical potential of the EMD means an electrical potential of the EMD with respective to a reference electrode made of mercury oxide (Hg/HgO) in a KOH aqueous solution (KOH content: 40% by mass) at 20±1° C.

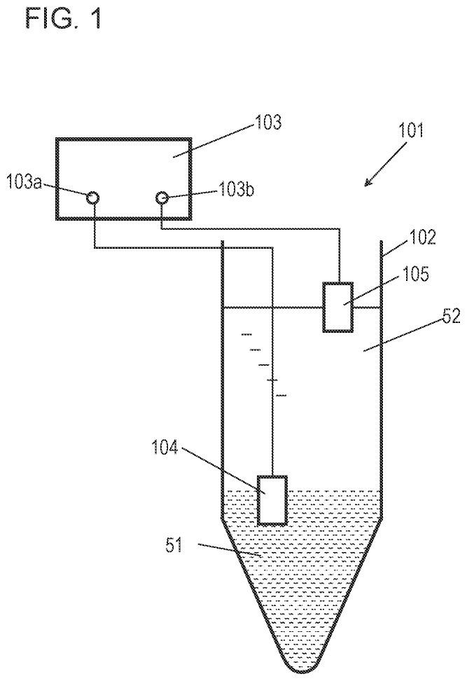

The electrical potential of the EMD may be measured by, e.g., the following procedure. FIG. 1 is a schematic diagram of apparatus 101 for measuring the electrical potential of the EMD.
(1) An unused battery is disassembled. Then, a positive electrode is taken out from the battery, dried, and crushed with a mortar or the like to prepare powder sample (positive-electrode powder). The powder sample may be an EMD powder.
(2) 2 g of powder sample 51 (positive-electrode powder or EMD powder) and 20 ml of a 40% by mass KOH aqueous solution is put in centrifuge tube 102, thereby preparing a sample liquid (dispersion liquid of the powder sample). The sample liquid is stirred, and them, is left at 20° C. for 24 hours.
(3) After that, the sample liquid is centrifuged to deposit powder sample 51 on a bottom of centrifuge tube 102.
(4) Platinum electrode 104 is put into the sample liquid (20±1° C.) which having been centrifuged and contacts the deposited powder sample 51, and reference electrode 103 (Hg/HgO) is put in supernatant liquid 52 (40% by mass KOH aqueous solution) in the sample liquid. Platinum electrode 104 and reference electrode 103 are connected to positive side 103a and negative side 103b of digital volt meter 103, respectively. The electrical potential difference (voltage) that is taken as the electrical potential of the EMD with respect to reference electrode 103 is measured.

The Na content (ppm by mass) in the positive electrode means the ratio (parts per million) of the mass of Na contained in the positive electrode to the mass of the entire positive electrode. The Zn content (ppm by mass) in the positive electrode means the ratio (parts per million) of the mass of Zn contained in the positive electrode to the mass of the entire positive electrode. The Na content and Zn content in the positive electrode are the amount of Na and amount of Zn contained in the positive electrode of the unused alkaline dry battery, respectively, after one week or more elapsed after the battery has been manufactured.

Even the positive-electrode active material employing the EMD providing high electrical potentials of 300 mV or higher enhances high-rate discharge performance. However, the EMD providing the electrical potential of the EMD exceeding 340 mV may not cause the open circuit voltage (OCV) of the battery to meet the International Electrotechnical Commission (IEC) standard (IEC 60086-2 Ed. 14 2021).

Even in the case that the EMD providing high electrical potentials of 300 mV or higher is employed, the Na content and Zn content in the positive electrode decreased within the respective ranges described above reduces needle crystals of zinc oxide deposited on the positive electrode during medium-rate discharge. The internal short circuit due to the deposited needle crystals in question can be reduced. The electrical potential of the EMD may be 320 mV or higher. However, the electrical potential of the EMD exceeding 340 mV may hardly reduce the deposited needle crystals of zinc oxide even is the amount of Na and amount of Zn in the positive electrode are decreased.

The Na content in the positive electrode being 3000 ppm by mass or less sufficiently reduces the ZnO deposited on the positive electrode during discharge. The Zn content in the positive electrode being 4600 ppm by mass or less sufficiently reduces the amount of ZnO deposited on the positive electrode during discharge.

The Na content in the positive electrode being 800 ppm by mass or more appropriately increases pH of the positive electrode, and reduces corrosion of the constituent members, such as a case, of the battery. A predetermined amount of a neutralizing agent containing Na is used in manufacturing the EMD described later, and a predetermined amount of a gelling agent containing Na is used in producing the negative electrode. Therefore, the positive electrode may contain 800 ppm by mass or more of Na.

For the purpose of reducing the dissolution of a negative-electrode active material containing Zn, a predetermined amount of zinc oxide is added to the electrolyte. Since the electrolyte containing such zinc oxide is retained in the positive electrode, the positive electrode may contain 2400 ppm by mass or more of Zn.

The Na contained in the positive electrode is derived from, e.g., the neutralizing agent (e.g., sodium hydroxide) containing Na used in a neutralization process in manufacturing the EMD and the gelling agent (e.g., sodium polyacrylate) containing Na used in producing the negative electrode. The Na content in the positive electrode may be adjusted by changing the concentration and used amount of the neutralizing agent, the amount of addition of the gelling agent containing Na used in producing the negative electrode, and the like.

The Zn contained in the positive electrode is derived mainly from zinc oxide contained in the electrolytes. These electrolytes are used in manufacturing the alkaline dry battery: the electrolyte for impregnation of the separator (liquid used for injection into the case), and the electrolyte for producing the negative electrode. The Zn content in the positive electrode may be adjusted by changing the content of zinc oxide and the like in these electrolytes.

The Na content in the positive electrode is preferably 2300 ppm by mass or more and 2900 ppm by mass or less. In order to easily reduce the dissolution of the negative-electrode active material, the Zn content in the positive electrode is preferably 3500 ppm by mass or more and 4500 ppm by mass or less.

The Na content (ppm by mass) and Zn content (ppm by mass) in the positive electrode may be determined by the following processes:
(i) An alkaline dry battery (unused battery after a lapse of one week or more from its manufacturing) is disassembled to take out the positive electrode. The positive electrode is placed on a paper sheet (filter paper) to allow electrolyte adhering the surface of the positive electrode to naturally fall for 5 minutes, thereby removing the electrolyte adhering onto the surface of the positive electrode. At that moment, the electrolyte having naturally fallen is absorbed in the filter paper, so that the fallen electrolyte is no longer contained in the electrolyte retained in the positive electrode (electrolyte in the positive electrode).
(ii) The positive electrode is dissolved with hydrochloric acid to obtain a measurement sample. Specifically, 10 mL of hydrochloric acid is added to 1 g of the positive electrode and the mixture is heated for 2 hours. Then, insoluble matter in the mixture is removed by filtering, and then, ion-exchanged water is added to adjust its volume to 100 mL, thereby obtaining the measurement sample. The amount of Na and the amount of Zn in the measurement sample are measured by inductively coupled plasma (ICP) optical emission spectroscopy. The Na content and Zn content in the positive electrode are determined based on the measurements. In the measurement, the measurement sample is used after having been 10-fold diluted with ion-exchanged water. As an analyzing apparatus, an ICP-OES analyzer (manufactured by Thermo Fisher Scientific Inc., Model “iCAP 7400”) may be used.

The Na content (ppm by mass) of the EMD used in producing the positive electrode may be determined in the same way as the process (ii) described above.

The positive electrode retains the electrolyte therein. The electrolyte is a

potassium hydroxide (KOH) aqueous solution containing zinc oxide. The electrolyte retained in the positive electrode (electrolyte contained in the positive electrode) is the electrolyte in the positive electrode described above. The content of the electrolyte in the positive electrode may be 10% by mass or more and 13% by mass or less, or may be 10.7% by mass or more and 12.6% by mass or less. In this case, the Na content and Zn content in the positive electrode are easily adjusted to within the respective ranges described above while preserving the battery's excellent discharge performance. The content (% by mass) of the electrolyte in the positive electrode means the ratio (percentage) of the mass of the electrolyte contained in the positive electrode to the mass of the entire positive electrode.

Most of the Na and Zn in the positive electrode are contained in the electrolyte retained in the positive electrode. The Na content and Zn content in the positive electrode may be adjusted by changing the content of the electrolyte in the positive electrode. The content of the electrolyte in the positive electrode may be adjusted by changing, for example, the density of the positive electrode or the content of graphite in the positive electrode. Graphite is typically contained in the positive electrode as a conductive agent, and is used in mixture with the EMD. The more the content of graphite and the higher the density of the positive electrode, the greater the positive electrode tends to have difficulty in retaining the electrolyte. The density of the positive electrode means the density of the positive electrode before the electrolyte with which the separator is impregnated permeates into a positive electrode pellet securely contacting an inner surface of the case.

The content of the electrolyte in the positive electrode may be determined as follows.

The content of the electrolyte is determined based on the contents of water, K, and Zn in the positive electrode. The water, K, and Zn in the positive electrode are derived from water, KOH, and ZnO in the electrolyte, respectively. Specifically, first, as in process (i) described above, the positive electrode after the electrolyte adhering the surface of the positive electrode is removed is obtained. After that, 10 g of the positive electrode is taken, held at 140° C. for 15 minutes to remove water, and then, a weight of the positive electrode is measured, and then the decrease in weight from 10 g is determined as the amount of water M (g). The water content (% by mass) of the positive electrode is determined by (M/10)×100. Separately, as in (ii) described above, the K content (% by mass) and Zn content (% by mass) in the positive electrode are determined, and the resulting values are converted to the KOH content (% by mass) and the ZnO content (% by mass), respectively. The resulting water content, the KOH content, and the ZnO content are summed to determine the electrolyte content (% by mass) in the positive electrode.

Hereinafter, alkaline dry batteries according to the embodiments will be detailed with reference to the accompanying drawings. The present disclosure is not limited to the embodiments described below. Moreover, various changes may be made as desired within the scope where advantages of the present disclosure are ensured. One embodiment may be combined with another embodiment.

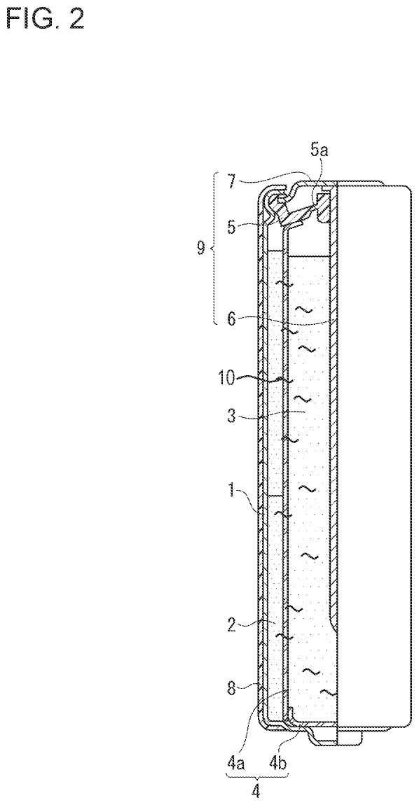

FIG. 2 is an elevational view of an alkaline dry battery according to an embodiment of the present disclosure with a lateral half thereof illustrated as a cross-sectional view.

As shown in FIG. 2, the alkaline dry battery includes power generating elements including cylindrical positive electrode 2 with a hollow, gelled negative electrode 3 disposed in the hollow of positive electrode 2, separator 4 disposed between these electrodes, and electrolyte 10. Electrolyte 10 is an alkaline electrolyte. The power generating elements are accommodated in cylindrical metal case 1 with a bottom functioning as a positive electrode terminal. Case 1 is made of, e.g., a nickel-plated steel plate. Positive electrode 2 contacts the inner surface of case 1. For enhancing the adhesion properties between positive electrode 2 and case 1, the inner surface of case 1 is preferably covered with a carbon coating.

Cylindrical separator 4 with a bottom includes cylindrical separator 4a and bottom paper 4b. Separator 4a is disposed along an inner surface of the hollow of positive electrode 2, thereby isolating positive electrode 2 from negative electrode 3. Therefore, the separator disposed between the positive and negative electrodes is cylindrical separator 4a. Bottom paper 4b is disposed at the bottom of the hollow of positive electrode 2, thereby isolating negative electrode 3 from case 1.

Case 1 has an opening therein sealed with sealing unit 9. Sealing unit 9 includes resin gasket 5, negative-electrode terminal plate 7 functioning as a negative electrode terminal, and negative-electrode current collector 6. Gasket 5 has a ring shape and has locally-thin portion 5a. When an internal pressure of the battery exceeds a predetermined value, the pressure breaks locally-thin portion 5a to release gas to the outside of the battery. Negative-electrode current collector 6 is inserted into negative electrode 3. The material of negative-electrode current collector 6 is an alloy, such as brass containing copper and zinc. Negative-electrode current collector 6 may be plated, such as tin-plated, if necessary. Negative-electrode current collector 6 has a nail shape having a head and a body portion. The body portion is inserted into a through-hole formed in the center of a cylindrical portion of gasket 5. The head portion of negative-electrode current collector 6 is welded to a flat portion of negative-electrode terminal plate 7 provided at a center of negative-electrode terminal plate 7. The opening end of case 1 is crimped via the peripheral end portion of gasket 5 to a flange of negative-electrode terminal plate 7 provided at a circumference of negative-electrode terminal plate 7. An outer surface of case 1 is wrapped with outer label 8.

Positive electrode 2 contains the EMD as a positive-electrode active material and the electrolyte. The EMD is used in powder form. In order to secure, e.g., the fillability for the positive electrode and the diffusivity of the electrolyte in the positive electrode, the average particle diameter of the EMD is, e.g., 30 μm or more and 60 μm or less. From the viewpoint of the moldability and suppression of expansion of the positive electrode, the BET specific surface area of the EMD may be, e.g., 20 m²/g or more to 50 m²/g or less.

In the present specification, the average particle diameter refers to the median diameter (D50) in a volumetric particle-size distribution. The average particle diameter may be determined with a laser diffraction/scattering-type particle-size distribution measuring apparatus. The BET specific surface area is determined by measuring and calculating a surface area using a BET equation, a theoretical formula of multilayer adsorption. The BET specific surface area may be measured with, e.g., a specific surface area measuring apparatus by, e.g., a nitrogen adsorption method.

Positive electrode 2 may further contain a conductive agent in addition to the EMD and the electrolyte. Examples of the conductive agent include a carbon black, such as an acetylene black, as well as an electrically conductive carbon material, such as graphite. The graphite may employ a natural graphite, an artificial graphite, or any other graphite. The conductive agent may be in fiber form or any other form, but preferably in powder form. The average particle diameter of the conductive agent may be selected from the range 5 nm or more and 50 μm or less. The average particle diameter of the conductive agent of the carbon-black conductive agent is preferably 5 nm or more and 40 nm or less. The average particle diameter of the conductive agent of the graphite conductive agent is preferably 3 μm or more and 50 μm or less.

The graphite content in a positive-electrode material mixture may be 3 parts by mass or more and 8 parts by mass or less with respect to 100 parts by mass of the total of the EMD and the graphite, and preferably 4 parts by mass or more and 7 parts by mass or less with respect to 100 parts by mass of the total of the EMD and the graphite. In the case that the graphite content is 7% by mass or less, the amount of filling of the EMD tends to be sufficiently secured, easily exhibiting preferable medium-rate discharge performance.

Positive electrode 2 is obtained by compressing and molding the positive-electrode material mixture in, e.g., a pellet form with the mixture containing the positive-electrode active material, the conductive agent, and the alkaline electrolyte. The positive-electrode material mixture may be temporally processed to have flake or granular shapes, and then, is classified, if necessary, and then, is subjected to compression-molding into pellets. After being accommodated in the case, the pellets may be subjected to secondary compression with a predetermined tool, such that the pellets securely contact the inner surface of the case. The average density of the EMD in the positive electrode pellets is, for example, 2.78 g/cm³ or more and 3.08 g/cm³ or less. The density of the positive electrode pellets may be 3.2 g/cm³ or more and 3.6 g/cm³ or less. The positive electrode (positive-electrode material mixture) may further contain other components (e.g., polytetrafluoroethylene), if necessary.

Negative electrode 3 has a gelled form. That is, negative electrode 3 contains a gelling agent in addition to the negative-electrode active material and the electrolyte. The negative-electrode active material contains either zinc or a zinc alloy. From the viewpoint of corrosion resistance, the zinc alloy preferably contains at least one selected from the group consisting of indium, bismuth and aluminum. The electrolyte used for producing the negative electrode may employ the same electrolyte as that used for impregnating the separator.

The negative-electrode active material is used typically in powder form. From the viewpoint of the fillability of the negative electrode and the diffusivity of the alkaline electrolyte in the negative electrode, the average particle diameter of powder of the negative-electrode active material is, for example, 80 μm or more and 200 μm or less, and preferably 100 μm or more and 150 μm or less.

As the gelling agent, any known gelling agent used in the field of alkaline dry batteries may be used without particular limitations, and water-absorbing polymers or the like may be used, for example. Examples of such a gelling agent include, for example, polyacrylic acid and sodium polyacrylate. The Na content in the positive electrode may be adjusted by changing the content of the gelling agent (e.g., sodium polyacrylate) containing Na in the negative electrode. The amount of addition of the gelling agent may be 0.5 parts by mass or more and 2 parts by mass or less with respect to 100 parts by mass of the negative-electrode active material. The Na content in the positive electrode may be adjusted by changing the compounding ratio of the polyacrylic acid and the sodium polyacrylate provided that the amount of addition of the gelling agent is in the range described above.

Separator 4 may employ, for example, a nonwoven fabric or microporous film. Examples of the material of the separator include cellulose and polyvinyl alcohol. The nonwoven fabric may employ a fabric mainly composed of any of these materials, for example. The microporous film may employ cellophane or the like. The thickness of the separator may be 150 μm or more and 300 μm or less, and may be 180 μm or more and 300 μm or less. The separator may be formed by stacking plural sheets (e.g., nonwoven fabric) wo have a thickness within the range described above.

In FIG. 2, cylindrical separator 4 with the bottom includes cylindrical separator 4a and bottom paper 4b, but is not limited to thereto. As the separator, a one-piece body with a cylindrical shape with a bottom may be used, and any separator with a known shape used in the field of alkaline dry batteries may be used.

The electrolyte contained in the battery (in the positive electrode, negative electrode, and separator) is a potassium hydroxide aqueous solution (alkaline electrolyte). The content of potassium hydroxide in the electrolyte is, for example, 30% by mass or more and 50% by mass or less. The electrolyte further contains zinc oxide. The content of zinc oxide in the electrolyte is, for example, 1% by mass or more and 5% by mass or less. The contents (% by mass) of the potassium hydroxide and zinc oxide in the electrolyte are the respective ratios (percentage) of respective masses of the potassium hydroxide and zinc oxide contained in the electrolyte to the mass of the entire electrolyte.

### EXAMPLES

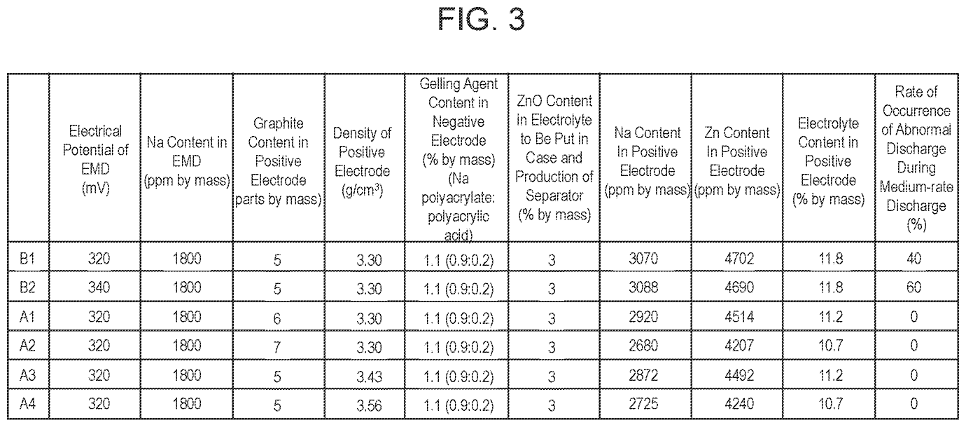

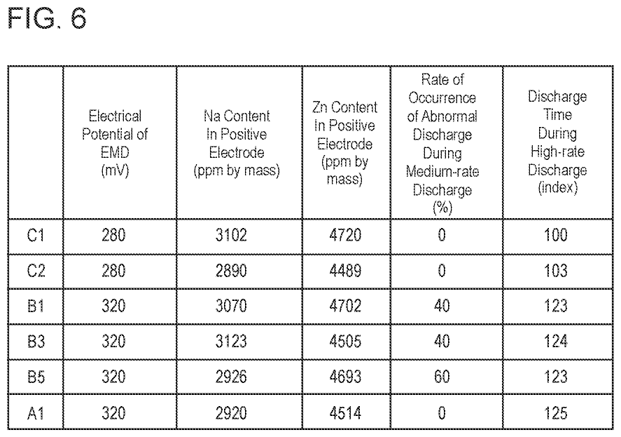

The present disclosure will be specifically described based on Examples and Comparative Examples; however, the present disclosure is not limited to the Examples described below. FIGS. 3-6 show the evaluation results of the alkaline dry batteries according to an embodiment of the present disclosure.

### Examples 1-21, Comparative Examples 1-8

According to the following procedures, AA cylindrical alkaline dry batteries (LR6) shown in FIG. 2 were produced.

### Production of Positive Electrode

0.2 parts by mass of polytetrafluoroethylene as an additive was added to a total, 100 parts by mass, of a positive-electrode active material powder (average particle diameter of 35 μm) and a graphite powder (average particle diameter of 8 μm), thereby providing a mixture. 2 parts by mass of an electrolyte was added to 100.2 parts by mass of the mixture and thoroughly stirred, and then, was compressed and molded to have flake shapes, thereby providing a positive-electrode material mixture. As the electrolyte, a KOH aqueous solution containing ZnO was used. The KOH content and ZnO content in the electrolyte were 40% by mass and 2% by mass, respectively.

As the positive-electrode active material, EMDs having the electrical potentials and Na contents indicated in FIGS. 3-5 were used. The electrical potentials of the EMDs and the Na contents in the EMDs were determined by the method described above. The electrical potentials of the EMDs indicated in FIGS. 3-5 indicate the electrical potentials with respect to those of reference electrode 103 made of mercury oxide (Hg/HgO). The graphite contents in the positive electrodes (positive-electrode material mixtures) were set to the values indicated in FIGS. 3-5. In FIGS. 3-5, the graphite contents in the positive electrodes indicate the amounts (parts by mass) of graphite with respect to 100 parts by mass of the total of the EMD and the graphite.

The flake-like positive-electrode material mixture was crushed into granules, and then, was classified with 10-100 mesh sieves. A predetermined amount of the thus-classified granules was compressed and molded to have a predetermined hollow cylindrical shapes having an inner diameter of 8.9 mm and an outer diameter of 13.65 mm, thereby producing two positive electrode pellets.

### Production of Negative Electrode

Gelled negative electrode 3 was prepared by mixing 100 parts by mass of a negative-electrode active material, 50 parts by mass of an electrolyte, and a gelling agent. The negative-electrode active material used here was a zinc alloy powder (average particle diameter of 130 μm) that contained 0.02% by mass of indium, 0.01% by mass of bismuth, and 0.005% by mass of aluminum.

As the electrolytes, KOH aqueous solutions containing ZnO were used. The KOH content in the electrolytes was set to 33% by mass. The ZnO contents in the electrolytes were set to the values indicated in FIGS. 3-5.

The gelling agents used here were each a mixture of a cross-linked branched polyacrylic acid and a highly cross-linked linear sodium polyacrylate (Na polyacrylic acid). The contents of the gelling agents in the negative electrodes were set to the values indicated in FIGS. 3-5. In FIGS. 3-5, the contents of the gelling agents in the negative electrodes indicate the amounts (parts by mass) of the gelling agents with respect to 100 parts by mass of the negative-electrode active material. The values inside the parentheses each indicate a mass ratio of Na polyacrylate to polyacrylic acid (Na polyacrylate: polyacrylic acid).

Assembling of Alkaline Dry Battery

Cases 1 each of which was a bottomed-cylindrical case (outer diameter of 14.0 mm, height of 49.9 mm) made of a nickel-plated steel sheet were prepared. Case 1 had an inner surface covered with a carbon coating. The two positive electrode pellets were inserted longitudinally in series into case 1, and then pressurized to form positive electrode 2 to securely contact the inner wall surface of case 1. The density of the positive electrode (positive electrode pellets) securely contacting the inner surface of the case is shown in FIGS. 3-5.

Cylindrical separator 4 with the bottom was disposed inside positive electrode 2. Then, a predetermined amount of the electrolyte was put into case 1 and absorbed by separator 4. Separator 4 included cylindrical separator 4a and bottom paper 4b. Cylindrical separator 4a had a thickness of 200 μm that was formed by twice rolling up a nonwoven fabric sheet having a thickness of 100 μm. The electrolyte used here for impregnating the separator (liquid for injection into the case) was the same as the electrolyte used for producing the negative electrode. The product in process was left in this state for a predetermined period of time, thereby allowing the electrolyte to permeate from separator 4 to positive electrode 2. After that, 6.6 g of gelled negative electrode 3 filled inside separator 4.

Sealing unit 9 including gasket 5, negative-electrode terminal plate 7, and negative-electrode current collector 6 was disposed at the opening of case 1. At this moment, the body portion of negative-electrode current collector 6 was inserted into negative electrode 3. The opening end of case 1 was crimped to the circumference of negative-electrode terminal plate 7 via gasket 5, thereby sealing the opening of case 1. The outer surface of case 1 was wrapped with outer label 8, thereby providing the alkaline dry batteries. In FIGS. 3-5, A1 to A21 are the batteries of Examples 1 to 21, and B1 to B8 are the batteries of Comparative Examples 1 to 8.

The Na contents, Zn contents, and electrolyte contents in the positive electrodes which were determined by the method described above are indicated in FIGS. 3-5.

Each of batteries of the Examples and Comparative Examples was subjected to Evaluation 1 as follows:

Evaluation 1: Rate of Occurrence of Abnormal Discharge during Medium-Rate Discharge

One battery was connected in series to a resister of 3.9 Ω and repeatedly subjected to a step once a day in which the battery was discharged through the load of 3.9 Ω for one hour in an environment at 20±2° C. At this moment, the discharge time (cumulative time of 1-hour discharge) required for the closed-circuit voltage of the battery to reach 0.9 V, was checked. In the case of the discharge time is less than 8 hours, the battery is determined to have been subjected to an abnormal discharge. The abnormal discharge occurs due to an internal short circuit that is caused by needle crystals of ZnO deposited on the positive electrode in course of the discharge.

The discharge time was measured for each of the five batteries, and the number of batteries in which abnormal discharges occurred was determined. The ratio, to the five, of the number of the batteries in which the abnormal discharges occurred is determined as the rate of occurrence of abnormal discharge. The evaluation results are shown in FIGS. 3-5.

In batteries A1-A4 shown in FIG. 3, by appropriately adjusting the graphite contents of the positive electrodes and/or the densities of the positive electrodes (positive electrode pellets), the Na contents and Zn contents in the positive electrodes were reduced to 3000 ppm by mass or less and 4600 ppm by mass or less, respectively. For each of batteries A1-A4, the rate of occurrence of abnormal discharge during the medium-rate discharge is 0 (zero) %.

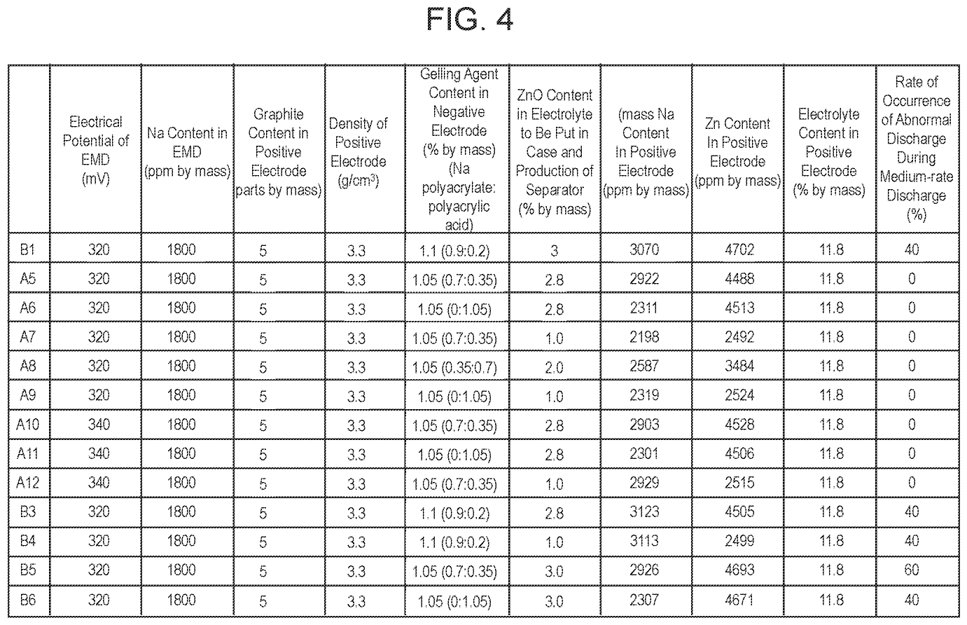

In batteries A5-A12 shown in FIG. 4, the contents of Na polyacrylate in the negative electrodes and/or the ZnO contents in the electrolytes used for impregnating the separators and for producing the negative electrodes were appropriately adjusted. This reduced the Na contents and Zn contents in the positive electrodes to 3000 ppm by mass or less and 4600 ppm by mass or less, respectively. For each of batteries A5-A12, the rate of occurrence of abnormal discharge during the medium-rate discharge is 0 (zero) %.

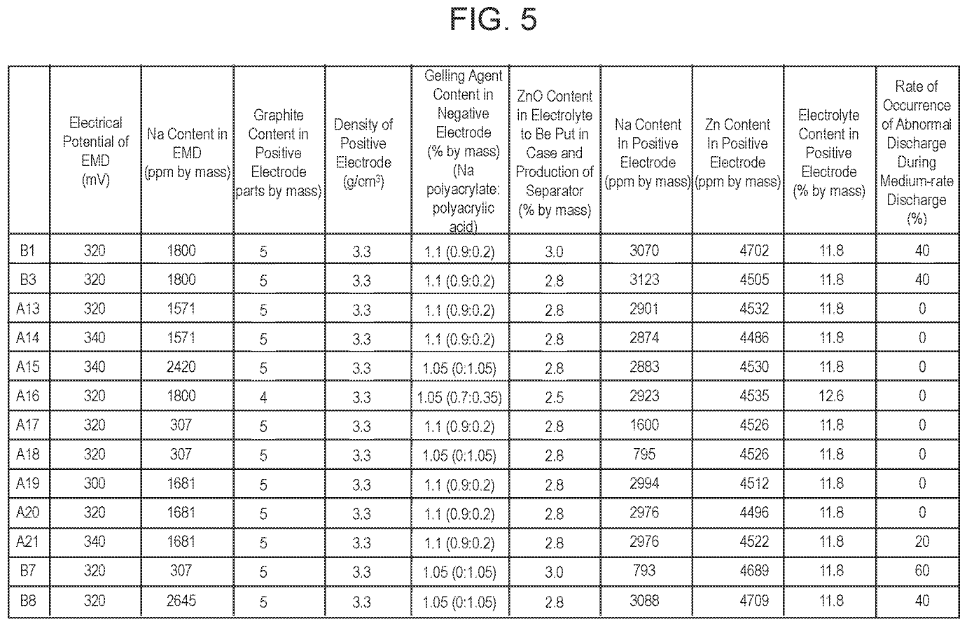

In batteries A13-A21 shown in FIG. 5, the Na contents in the EMDs were appropriately adjusted. Further, if necessary, the contents of Na polyacrylate in the negative electrodes and/or the ZnO contents in the electrolytes used for impregnating the separators and for producing the negative electrodes were appropriately adjusted. This reduced the Na contents and Zn contents in the positive electrodes to 3000 ppm by mass or less and 4600 ppm by mass or less, respectively. In each of batteries A13-A20, the rate of occurrence of an abnormal discharge during the medium-rate discharge is 0 (zero) %. In battery A21, the rate of occurrence of an abnormal discharge during the medium-rate discharge is reduced to 20%.

In contrast, in batteries B1-B8, the Na contents and/or Zn contents in the positive electrodes increased, and their rates of occurrence of abnormal discharges during the medium-rate discharge increase to 40% or more.

In batteries A13-A15, A17-A21, B7, and B8, their EMDs were subjected to washing treatment to adjust the Na contents in their EMDs. Specifically, 300 g of the EMD was washed with 1.8 L of a cleaning fluid (NaOH aqueous solution, pure water, or dilute sulfuric acid) at 25° C. for a predetermined period of time. Then, the cleaning fluid was removed by filtering, and then, the EMD was dried by blowing hot air at 100° C. for 20 minutes. In battery B8, the cleaning fluid used was a NaOH aqueous solution (concentration of 16.2 mmol/L) and the washing period of time was one hour. In batteries A13 and A14, the cleaning fluid used was pure water and the washing period of time was 20 minutes. In battery A15, the cleaning fluid used was a NaOH aqueous solution (concentration of 12.2 mmol/L) and the washing period of time was one hour. In batteries A17, A18, and B7, the cleaning fluid used was dilute sulfuric acid (concentration of 50 mmol/L) and the washing period of time was one hour. In batteries A19-A21, the cleaning fluid used was pure water and the washing period of time was 10 minutes.

### Comparative Example 9

Battery C1 of Comparative Example 9 was produced in the same manner as battery B1 of Comparative Example 1 except that an EMD providing an electrical potential of 280 mV was used.

### Comparative Example 10

Battery C2 of Comparative Example 9 was produced in the same manner as battery A1 of Example 1 except that an EMD providing an electrical potential of 280 mV was used.

Batteries C1 and C2 were subjected to Evaluation 2 described below as well as Evaluation 1 described above.

Batteries A1, B1, B3, and B5 as well were subjected to Evaluation 2 described below.

### Evaluation 2: High-Rate Discharge Performance

In an environment at 20±2° C., a pulse discharge was performed in which a discharge at 1.5 W for 2 seconds and a discharge at 0.65 W for 28 seconds were alternately repeated 10 times, followed by being at rest for 55 minutes. This constituted a step and the step was repeatedly carried out. At this moment, the discharge time (cumulative time of pulse discharge) required for the closed-circuit voltage of the battery to reach 1.05 V, was measured.

The evaluation results for batteries C1 and C2 are shown in FIG. 4 together with the evaluation results for batteries A1, B1, B3, and B5. The values of discharge time for the high-rate discharge shown in FIG. 4 are expressed as indices for with the discharge time of battery C1 of Comparative Example 9 being 100.

In batteries C1 and C2, the electrical potentials of their EMDs were lower than 300 mV and abnormal discharge did not occur for the medium-rate discharge; however, they exhibited decreased high-rate discharge performance.

In batteries B1, B3, and B5, the electrical potentials of their EMDs were 300 mV or higher and so they exhibit increased high-rate discharge performance; however, their rates of occurrence of abnormal discharge for the medium-rate discharge increase to 40% or more since at least one of the Na content and Zn content in their positive electrodes is large.

In battery A1, the electrical potential of the EMD was 300 mV or higher, resulting in an increase in the high-rate discharge performance. In battery A1, although the electrical potential of the EMD was 300 mV or higher, abnormal discharge did not occur during the medium-rate discharge because the Na content and Zn content in the positive electrode were 3000 ppm by mass or less and 4600 ppm by mass or less, respectively.

### INDUSTRIAL APPLICABILITY

An alkaline dry batteries according to the present disclosure are suitably applicable to power sources for portable audio devices, electronic game players, lights, and the like, for example.

### REFERENCE MARKS IN THE DRAWINGS

1 case

2 positive electrode

3 negative electrode

4 bottomed-cylindrical separator

4a cylindrical separator

4b bottom paper

5 gasket

5a locally-thin portion

6 negative-electrode current collector

7 negative-electrode terminal plate

8 outer label

9 sealing unit

10 electrolyte

104 reference electrode

1. An alkaline dry battery comprising a positive electrode, a negative electrode, and a separator disposed between the positive electrode and the negative electrode, wherein
the positive electrode contains electrolyte and the negative electrode contains electrolyte,
the positive electrode further contains electrolytic manganese dioxide, sodium, and zinc,
an electrical potential of the electrolytic manganese dioxide is 300 mV or higher and 340 mV or lower with respect to an electrical potential of a reference electrode made of mercury oxide,
a content of the sodium in the positive electrode is 800 ppm by mass or more and 3000 ppm by mass or less, and
a content of the zinc in the positive electrode is 2400 ppm by mass or more and 4600 ppm by mass or less.

2. The alkaline dry battery according to claim 1, wherein the content of the sodium in the positive electrode is 2300 ppm by mass or more and 2900 ppm by mass or less.

3. The alkaline dry battery according to claim 1, wherein a content of the electrolyte contained in the positive electrode is 10% by mass or more and 13% by mass or less.
